(19) United States
(12) Patent Application Publication
(10) Pub. No.: US 2023/0415255 A1
(43) Pub. Date: Dec. 28, 2023

(54) METHOD AND DEVICE FOR LIMITING ENERGY WHEN IGNITING AN ARC

(71) Applicant: Fronius International GmbH, Pettenbach (AT)

(72) Inventors: Andreas PRINZ, Wels-Thalheim (AT); Stefan AUMAIR, Wels-Thalheim (AT); Franz HOFMANNINGER, Wels-Thalheim (AT); Michael MUSS, Wels-Thalheim (AT)

(73) Assignee: Fronius International GmbH, Pettenbach (AT)

(21) Appl. No.: 18/037,707

(22) PCT Filed: Dec. 1, 2021
(86) PCT No.: PCT/EP2021/083682

§ 371 Date: May 18, 2023

(30) Foreign Application Priority Data
Dec. 2, 2020 (EP) 20211316.3

(51) Int. Cl. B23K 9/067

(52) U.S. Cl. CPC B23K 9/067

(57) ABSTRACT

To ensure safe operation of a welding apparatus, low-voltage pulses occurring on a low-voltage side of the welding apparatus are transformed into high-voltage pulses occurring on a high-voltage side of the welding apparatus, an arc is ignited between an electrode and a workpiece during an ignition mode and/or idling mode using the high-voltage pulses, provision is made, in the ignition mode and/or in the idling mode, for a time window that extends from a starting time point to an end time point, an amount of ignition energy at the electrode is determined during the time window and compared with an energy limit value, and an action is triggered in the event of the energy limit value being exceeded, in order to prevent further high-voltage pulses in the time window.

The present invention relates to a method for safe operation of a welding apparatus, low-voltage pulses occurring on a low-voltage side of the welding apparatus being transformed into high-voltage pulses occurring on a high-voltage side of the welding apparatus, an arc being ignited on an electrode during an ignition mode, using the high-voltage pulses. Furthermore, the present invention relates to an energy limiting unit for a welding apparatus having a low-voltage side and a high-voltage side, and a welding apparatus comprising a low-voltage source, which is designed to generate low-voltage pulses on the low-voltage side, and comprising a transformation unit for converting the low-voltage pulses generated on the low-voltage side to high-voltage pulses at a high-voltage side, for the purpose of igniting an arc between an electrode and a workpiece on the high-voltage side, and comprising an energy limiting unit according to the invention.

In some welding apparatuses, low-voltage pulses are transformed into high-voltage pulses. These high-voltage pulses usually contain an energy of 100 microjoules (μJ) up to 10 joules (J) and are used during an ignition process to ignite an arc at an electrode. After the ignition process, an actual welding process is carried out in the case of a burning arc, of course a much greater amount of energy occurs at the electrodes in this case, compared with the ignition mode. AT 413 953 B discloses a method for the contactless ignition of an arc using ignition pulses combined to form pulse packets. As a result, the amount of energy delivered during the ignition process is essentially kept low. WO 2012/162582 A1 describes the monitoring of an amount of energy delivered to the workpiece during the welding process.

The object of the present invention is to provide a method for the safe operation of a welding apparatus, and an energy limiting unit for a welding apparatus.

This object is achieved according to the invention in that, in the ignition mode, a time window that extends from a starting time to an end time is provided, an amount of ignition energy occurring at the electrode being determined during the time window and compared with an energy limit value and an action being triggered in the event of the energy limit value being exceeded, in order to prevent further ignition energy at the electrode in the time window. Furthermore, the object is achieved by means of an energy limiting unit, the energy limiting unit comprising an energy determination unit which is designed to determine an amount of ignition energy occurring at an electrode in an ignition mode of the welding apparatus during a time window which extends from a starting time to an end time. The energy limiting unit comprises an energy comparison unit which is designed to compare the amount of ignition energy with a predetermined energy limit value. The energy limiting unit further comprises a blocking unit which is designed to trigger an action when the energy limit value is exceeded, in order to prevent further ignition energy at the electrode in the time window. In addition, the object is achieved by a welding apparatus which comprises a low-voltage source, the low-voltage source being designed to generate low-voltage pulses on the low-voltage side, and comprising a transformation unit for converting the low-voltage pulses to high-voltage pulses applied to a high-voltage side for igniting an arc, and comprising an energy limiting unit according to the invention, the blocking unit being designed to prevent an occurrence of further ignition energy at the electrode by the action in the time window, in that further low-voltage pulses on the low-voltage side and/or high-voltage pulses on the high-voltage side and/or auxiliary voltage pulses on the high-voltage side are prevented in the time window. Preferably, the energy limit value for a defined period of time is in the range from 0.01 to 100 joules, preferably from 0.1 to 10 joules, particularly preferably from 0.5 joule to 5 joules. Furthermore, an energy limit value of 4 joules per second can also be sought.

It is thus possible to ensure, in the ignition mode and/or in the idle mode, and/or preferably in the welding mode, that the amount of ignition energy provided at the electrodes does not exceed an energy limit value, which makes it possible to prevent a user of the welding apparatus receiving a dangerous or harmful electric shock during the ignition process if said user touches the electrode or comes into contact with it. In contrast to the welding mode, during an ignition mode or an idle mode it is likely that the welder may come into contact with the high-voltage pulses, on the high-voltage side, since said pulses are applied to the electrode of the welding torch, although it may be the case that no arc occurs. Direct contact of the welder with the low-voltage pulses on the low-voltage side is, however, unlikely, since said pulses can be tapped only within the welding apparatus. In the case of the welding mode, high-voltage pulses occurring at the electrode (and optionally auxiliary voltage pulses—see below) are less critical for the welder, since the energy flows away almost completely via the workpiece, and it is unlikely that the welder will reach into the burning arc. Furthermore, an energy limitation may also be desired, under certain circumstances, in the welding mode, for which reason a verification can also be made in the welding mode as to whether the ignition energy exceeds the energy limit value, and an action can be triggered if said value is exceeded. A welding mode is understood to mean an arc which is at least temporarily maintained between an electrode and a workpiece and which introduces energy into the workpiece or onto the workpiece surface that is high enough to melt the workpiece surface, i.e., a structural change in the workpiece surface, or at least a general change in the workpiece surface, occurs. Furthermore, a welding mode is understood to mean an energy input into a workpiece at a power greater than 100 joules/second, greater than 10 joules/second, or greater than 4 joules/second. Preferably, the arc is already burning in the welding mode, whereas the arc is ignited in the ignition mode. An ignition mode is understood to mean the initial generation of an ionization path and/or the initial generation of an arc between an electrode tip and a workpiece, as well as, after an arc has been extinguished, the renewed generation of an ionization path and/or the renewed generation of an arc between an electrode tip and a workpiece. Furthermore, an ignition mode is understood to mean an energy input into a workpiece and/or an energy input into a gas path at a power of less than or equal to 4 joules/second. An idle mode describes the time between the achieved readiness for welding of a welding apparatus, and the initiation of the ignition mode. The amount of ignition energy can be determined in a hardware unit and/or in a software unit. The determination of the amount of ignition energy is preferably determined in a plurality of ways, in order to ensure high safety by redundancy.

Preferably, an amount of high-voltage energy of the high-voltage pulses is summed during the time window, and the amount of high-voltage energy is used to determine the amount of ignition energy occurring at the electrode. This can be done, for example, by integration of the high-voltage pulses occurring in the time window.

Furthermore, the amount of energy of one low-voltage pulse can be specified, and the high-voltage pulses occurring during the time window can be counted and multiplied by the amount of energy of one low-voltage pulse in order to determine the amount of high-voltage energy summed during the time window. It is preferably assumed that the amount of high-voltage energy corresponds to the amount of ignition energy (in particular if no auxiliary voltage pulses are provided; see below). A number of high-voltage pulses can be combined into high-voltage pulse packets, it being possible for a high-voltage pulse to have a time period of several nanoseconds up to several microseconds. Thus, the entire amount of energy of one low-voltage pulse packet and consequently of a high-voltage pulse packet can be known. In this way, the number of low-voltage pulse packets can in turn be counted during the time window, in order to determine the summed amount of high-voltage energy.

It is particularly advantageous if an amount of low-voltage energy of the low-voltage pulses is summed during the time window, and the amount of low-voltage energy is used to determine the amount of energy occurring at the electrode. The low-voltage pulses comprise the same energy content as the associated high-voltage pulses in the same period (apart from losses which can be computed and/or calculated and/or are constant). This makes it possible to determine the amount of high-voltage energy applied at the electrode by measuring the amount of low-voltage energy occurring at the low-voltage side. The amount of low-voltage energy can thus be used to determine the amount of ignition energy. It is preferably assumed that the amount of low-voltage energy corresponds to the amount of ignition energy (in particular if no auxiliary voltage pulses are provided; see below). A measurement of the amount of low-voltage energy on the low-voltage side is more cost-effective and less susceptible to faults than a measurement of the (equivalent) amount of high-voltage energy on the high-voltage side. High-voltage pulses may have voltages in the range of 1 kV to 50 kV, e.g. about 10 kV. The determination of the amount of low-voltage energy can be determined, for example, by integration of the low-voltage pulses in the time window.

Preferably, the amount of energy of one low-voltage pulse is predefined, and the low-voltage pulses occurring during the time window are counted and multiplied by the amount of energy of one low-voltage pulse, in order to determine the amount of low-voltage energy summed during the time window. An exact determination of the amount of low-voltage energy during the time window is thus possible.

In order to determine the amount of low-voltage energy, an amount of energy per time unit can also be specified for the low-voltage pulses. In this case, a time unit can be predefined as a physical unit for time measurement as seconds s, as milliseconds ms, or preferably also as microseconds μs. If the sum of the pulse durations of all the low-voltage pulses occurring in the time window is known within a time window, the sum of the pulse durations of the low-voltage pulses in the time window can be multiplied by the predetermined amount of energy per time unit in order to determine the amount of low-voltage energy in the time window. In order to determine the pulse durations of the low-voltage pulses, the pulse duration of each individual low-voltage pulse in the time window can be determined by software and/or hardware, and thus determined or measured. In this case, the amount of energy per time unit can preferably be specified in the unit J/μs.

If a number of high-voltage pulses are combined into high-voltage pulse packets, the low-voltage pulses can accordingly also be combined into low-voltage pulse packets. If the amount of energy of one low-voltage pulse packet is known, the number of low-voltage pulse packets can thus be counted during the time window in order to determine the amount of low-voltage energy summed during the time window.

As an action, the generation of further low-voltage pulses can be blocked, as a result of which in turn generation of high-voltage pulses is blocked. For this purpose, the blocking unit can be designed to block the generation of further low-voltage pulses as an action. The blocking unit can be designed such that it actively intervenes in a pulse generation unit provided for generating the low-voltage pulses, and consequently in the high-voltage pulses, in order to block the generation of the low-voltage pulses. This makes it possible to ensure that no further low-voltage pulses occur in the time window. The same or different energy limit values as those for the welding mode can be provided for an ignition mode. The energy limit value for the ignition mode can also be different from that for idle mode. The actions to be triggered can also differ for welding mode, ignition mode and idle mode, an occurrence of further ignition energy at the electrode being prevented by the different actions in the time window in each case.

The summation of the amount of low-voltage energy and/or the comparison with the low-voltage energy limit value and/or the triggering of the action can be deactivated when the welding apparatus is in a welding mode. However, it can also be provided that the summation of the amount of low-voltage energy and/or the comparison with the low-voltage energy limit value and/or the triggering of the action is activated when the welding apparatus is in a welding mode.

A detection unit can be provided, which is designed to distinguish a welding mode of the welding apparatus from an ignition mode and/or an idle mode of the welding apparatus, and to optionally deactivate the energy detection unit and/or the energy comparison unit and/or the blocking unit in the welding mode and to optionally activate it in the ignition mode and/or in the idle mode.

Ignition or re-ignition of an arc is carried out by the high-voltage pulses generated at the electrode. After the ignition process has been completed, a welding voltage is applied to the electrode, as a result of which a welding current flows. Since a high power output is desired during the welding process, the energy limitation could be deactivated in the welding mode.

A distinction between different operating modes of the welding apparatus (welding mode, ignition mode, idle mode, etc.) can be made very quickly and precisely by evaluating the current flow, a total current flow and/or an auxiliary current flow. In addition, the evaluation can take place directly in an inverter assigned to the welding apparatus, as a result of which the operating mode can be detected without additional delay and the safety function of the energy limiting unit can be activated immediately. By measuring the current flow in the detection unit, the time point when the ignition of the arc is complete can thus likewise be determined. Thus, the energy limitation of the overall system can be limited to the safety-relevant time point. In comparison to the process current measurement and/or process voltage measurement, which usually takes place outside the inverter, a direct current and/or voltage measurement directly in the inverter is significantly more advantageous with respect to the speed of the measurement, the measurement data evaluation and the susceptibility of a measurement to faults. As a result, a measurement in this form is preferably also used for safety-critical and safety-relevant applications.

However, if the welding apparatus is designed for AC voltage welding, a welding current occurring at the electrode has a zero-crossing that occurs preferably periodically. In order to prevent the arc from breaking during the zero-crossing, an additional auxiliary voltage, in particular an auxiliary DC voltage, may be provided, which may be, for example, 200 to 300 V. In the case of DC voltage welding, generally no zero-crossing, at which the arc could be extinguished, occurs during the welding process. Thus, in the case of welding apparatuses designed for DC voltage welding, typically no auxiliary voltage pulses are provided. The auxiliary voltage pulses, just like the high-voltage pulses, are applied at the electrode of the welding torch, as a result of which they are equally accessible to the welder during the ignition mode and/or the idle mode.

In the case of multi-process welding apparatuses, which control more than just one welding process, such as manual arc welding processes (MMA welding), MIG/MAG welding processes (metal inert gas welding/metal active gas welding) or TIG welding processes (tungsten inert gas welding), it is also conceivable to use an auxiliary voltage source for DC voltage welding. In this way, for example, the stability during process changes can be increased, for example in the case of a change from DC voltage welding to AC voltage welding. By using an auxiliary voltage source for DC voltage welding, it is also possible, in particular in MIG/MAG welding, to counteract erratic arcs.

Preferably, auxiliary voltage pulses are applied on the high-voltage side in order to assist the ignition of an arc, an amount of auxiliary voltage energy of the auxiliary voltage pulses being summed during the time window in order to determine an amount of auxiliary voltage energy, and the amount of auxiliary voltage energy being used to determine the amount of ignition energy occurring at the electrode. By triggering the action, further auxiliary voltage pulses are prevented in the time window.

In particular for AC voltage welding, with regard to the use of auxiliary voltage pulses, a distinction can be made between the ignition of the arc and the maintenance of the arc at a zero-crossing, in order to ensure that the limitation of the amount of auxiliary voltage energy takes place only in the safety-relevant time window, i.e., during an ignition and not during a zero-crossing.

In order to generate the auxiliary voltage pulses, the welding apparatus can comprise at least one auxiliary voltage source. The auxiliary voltage pulses can improve an ignition of the arc and are, for example, in a range from 100 V to 1 kV, preferably in a range from 200 V to 300 V. The auxiliary voltage pulses have a duration of several microseconds to several milliseconds.

Furthermore, the pulse duration of an auxiliary voltage pulse can be limited by software or hardware, such that the pulse duration of an auxiliary voltage pulse is, for example, at most 40 μs in ignition mode and/or for example at most 600 μs in the welding mode.

If auxiliary voltage pulses are provided, it is advantageous if the amount of ignition energy is determined from the sum of the amount of auxiliary voltage energy and the amount of high-voltage energy, or from the sum of the amount of auxiliary voltage energy and the amount of low-voltage energy.

The auxiliary voltage pulses can be temporally synchronized, preferably superimposed, with the high-voltage pulses. Furthermore, the high-voltage pulses can be temporally synchronized, preferably superimposed, with the auxiliary voltage pulses. Maintenance of the arc at the zero-crossing of the welding current can thus be facilitated. For synchronization, it is possible to use a feedback signal between the high-frequency (HF) ignition unit and the auxiliary voltage source. This has the advantage that no voltage measurement is required for the synchronization, as a result of which no disturbance variables or avoidable delays occur either. The feedback signal can, for example, be generated during each actuation of the high-frequency (HF) ignition unit and transmitted to the inverter and consequently to the auxiliary voltage source. The inverter preferably knows the delay times of the recharging processes of the high-frequency (HF) ignition unit, and also knows its own cycle times and the delay times of the auxiliary voltage source, and can thereby activate the auxiliary voltage source synchronously with the high-frequency pulses. Furthermore, here again, the high-voltage source could be activated synchronously with the auxiliary voltage source. It is advantageous if all the delay times are taken into account during the generation of the high-frequency pulses and during the generation of the auxiliary voltage pulses (print runtimes, switching operations, etc.) until the corresponding voltage is actually applied to the electrode, in order to enable precise synchronization. It is thus possible, depending on the application, to start the auxiliary voltage source in such a manner that a high-frequency pulse can be positioned shortly before, shortly after or during the auxiliary voltage application, and the ignition properties can be optimized according to the application.

The amount of energy of an auxiliary voltage pulse can be predefined, the auxiliary voltage pulses occurring during the time window being counted and multiplied by the amount of energy of an auxiliary voltage pulse, in order to determine the amount of auxiliary voltage energy summed during the time window. The amount of auxiliary voltage energy can also be determined by integration of the auxiliary voltage pulses in the time window.

For the auxiliary voltage pulses, too, it is possible, for calculating the amount of auxiliary voltage energy, to specify an amount of energy per time unit, for example likewise in the unit J/μs. In order to determine the amount of auxiliary voltage energy transported by the auxiliary voltage pulses, the pulse durations of the given auxiliary voltage pulses can be determined by software and/or hardware, and thus the sum of the pulse durations of the auxiliary voltage pulses occurring in a time window can be determined. The amount of auxiliary voltage energy transported by the auxiliary voltage pulses in a time window can thus be calculated by multiplication of the sum of the pulse durations of the auxiliary voltage pulses occurring in a time window with the predetermined amount of energy per time unit.

As an action, the generation of further auxiliary voltage pulses in the time window can also be blocked, for example by an auxiliary voltage source being deactivated.

An amount of residual energy can also be determined from a difference between the energy limit value and the amount of ignition energy in the time window; and it is possible to determine, on the basis of the amount of residual energy, whether further auxiliary voltage pulses and/or high-voltage pulses are prevented by a triggered action in the time window.

The summation of the amount of auxiliary voltage energy and/or the comparison with the auxiliary voltage limit value and/or the triggering of the further action can be deactivated when the welding apparatus is in a welding mode.

The energy limiting unit can be designed as an independent element, but also an integral component of the welding apparatus or as an integral component of welding components, such as an inverter or a high-frequency (HF) ignition unit. The energy determination unit(s) and/or energy comparison unit(s) and/or blocking unit(s) may be an integral part of an energy limiting unit or may be arranged in a distributed manner.

It is particularly advantageous if the time window is shifted continuously, such that the end time corresponds to the current time. In this way, the amount of energy of the low-voltage pulses is determined continuously during the time window ending at the current time, i.e., the time window extends into the past. This can be achieved in a simple manner by recording the low-voltage pulses at least over the duration of the time window. A real-time measurement of an amount of energy per observation period is thus obtained. The observation periods are preferably in the range from 0.01 to 60 seconds, preferably in the range from 0.25 to 5 seconds and particularly preferably in the range from 0.5 to 2 seconds. Furthermore, observation periods of 1 second can also be sought.

It is particularly advantageous if, before the energy limit value is exceeded, the amount of ignition energy currently occurring in the time window is determined and a generation of low-voltage pulses and/or auxiliary voltage pulses is already blocked in advance on the basis of the amount of ignition energy. Thus, in the case of an amount of ignition energy which is far from the energy limit value, it may be advantageous to block only the generation of low-voltage pulses or auxiliary voltage pulses instead of blocking further low-voltage pulses and auxiliary voltage pulses, if it is sufficiently probable that the energy limit value will not be reached even in the last case.

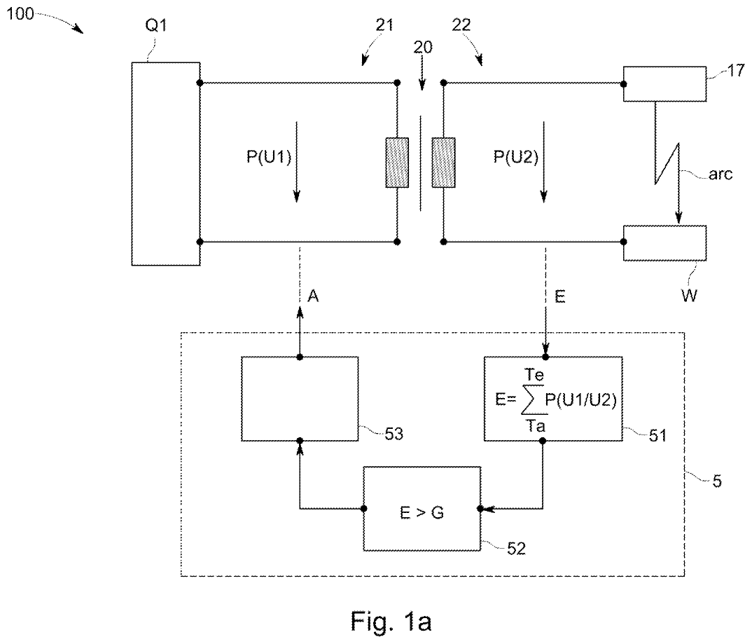

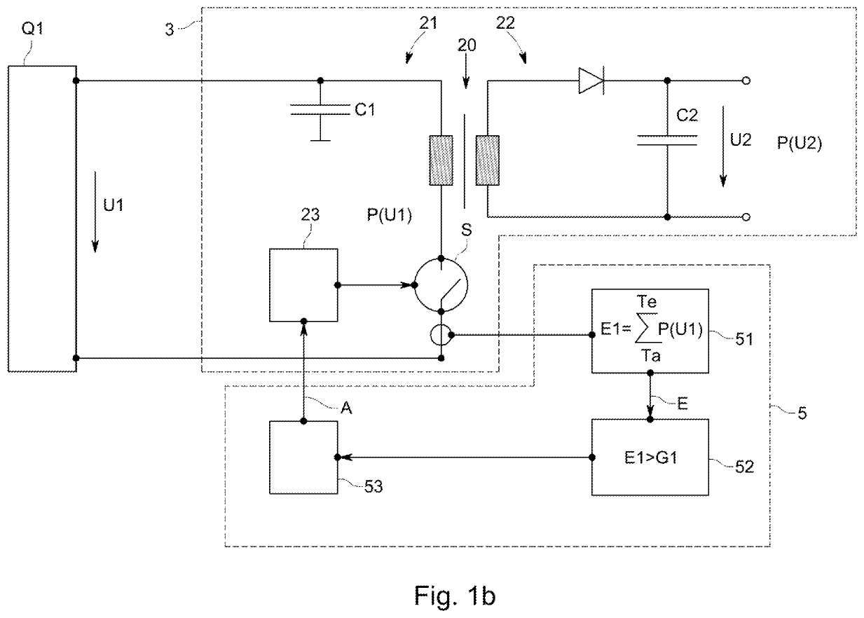

The present invention is explained in greater detail below with reference to FIG. 1a to 5d which show advantageous embodiments of the invention, by way of example and in a schematic and non-limiting manner. In the drawings:

FIG. 1a is a schematic view showing a structure of an energy limiting unit comprising an energy comparison unit, an energy determination unit and a blocking unit,

FIG. 1b is a schematic view showing a structure of a high-frequency (HF) ignition unit having an energy limiting unit comprising a low-voltage energy determination unit,

FIG. 1c is a schematic view showing a structure of an auxiliary voltage source having its own energy limiting unit comprising an energy determination unit,

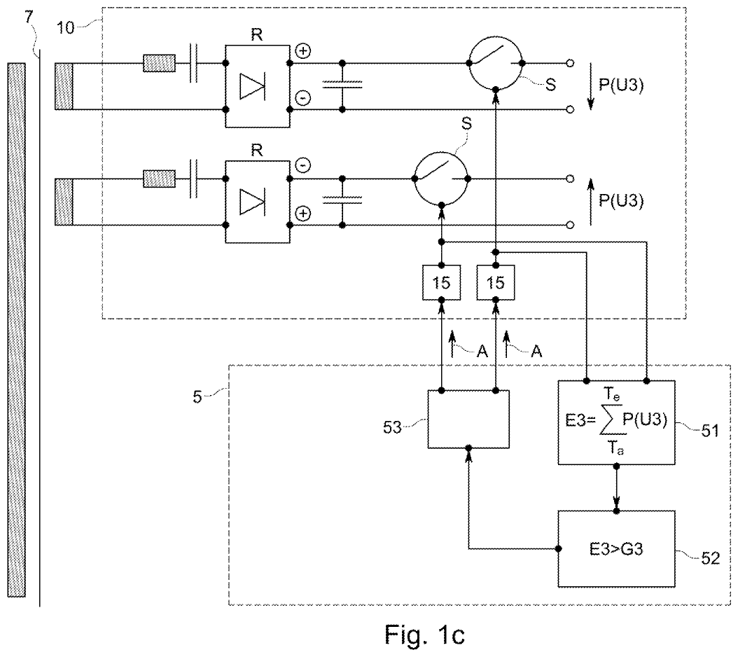

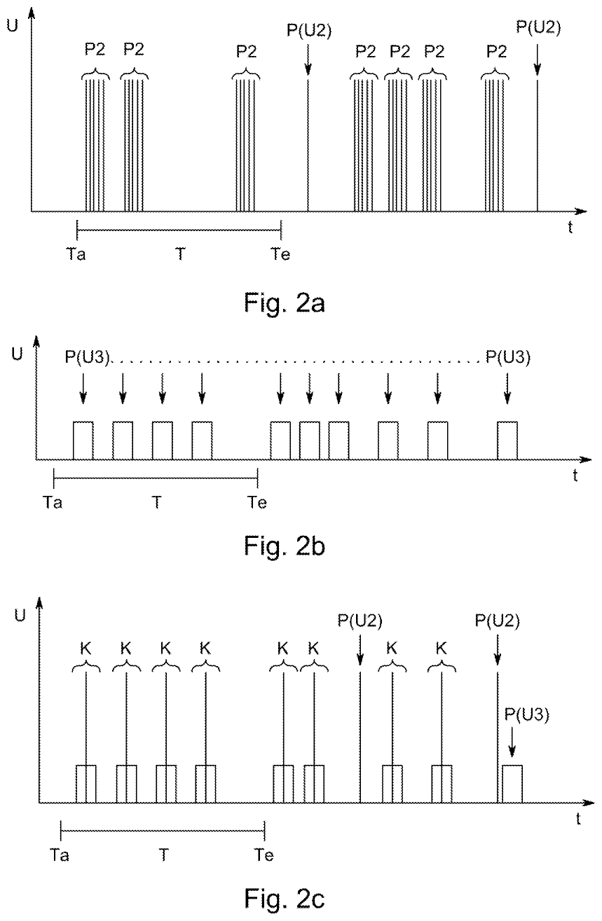

FIG. 2a shows a sequence of high-voltage pulses on a high-voltage side, and a time window,

FIG. 2b shows auxiliary voltage pulses occurring on a high-voltage side, and a time window,

FIG. 2c shows high-voltage pulses occurring on a high-voltage side and auxiliary voltage pulses which are at least partially synchronized with the high-voltage pulses, and a time window,

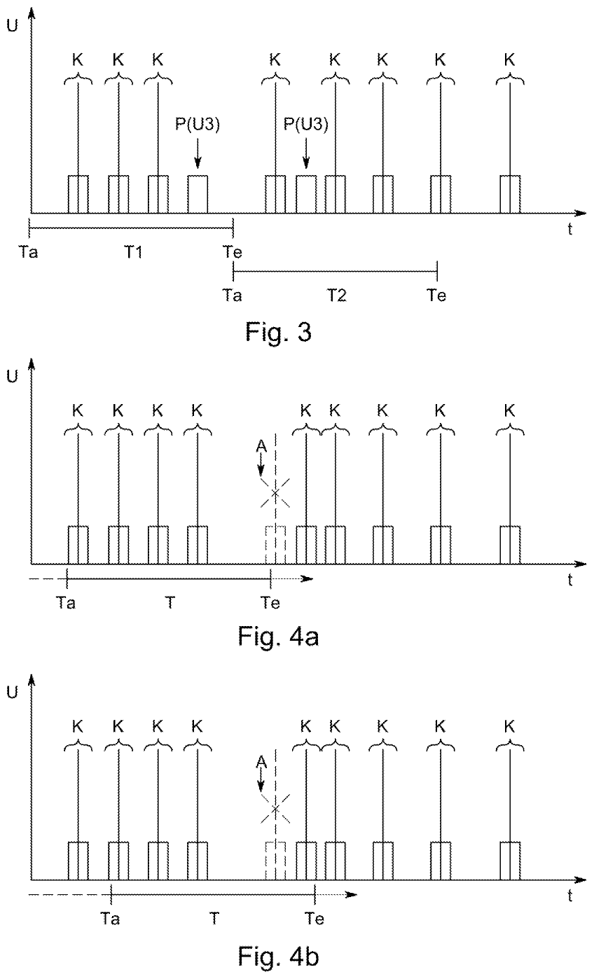

FIG. 3 shows two time windows, in each of which auxiliary voltage pulses and high-voltage pulses occur and in which in each case an energy limit value was not exceeded,

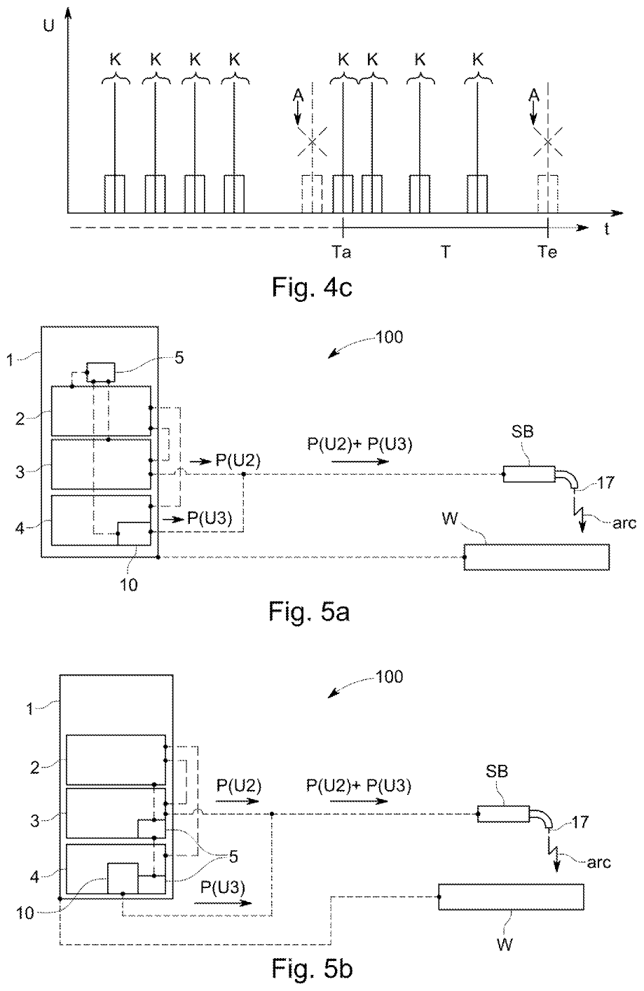

FIG. 4a shows a shiftable time window at a first point in time, in which auxiliary voltage pulses and mutually synchronized high-voltage pulses occur and in which an energy limit value would have been exceeded,

FIG. 4b shows a shiftable time window at a second point in time, in which auxiliary voltage pulses and mutually synchronized high-voltage pulses occur and in which an energy limit value was not exceeded,

FIG. 4c shows a shiftable time window at a third point in time, in which auxiliary voltage pulses occur and mutually synchronized high-voltage pulses occur and in which an energy limit value would have been exceeded,

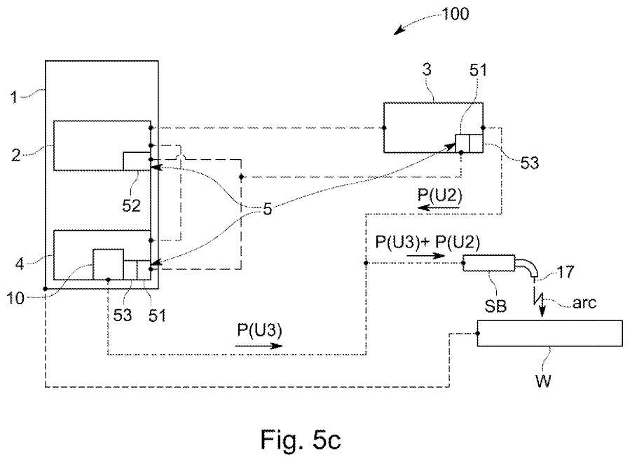

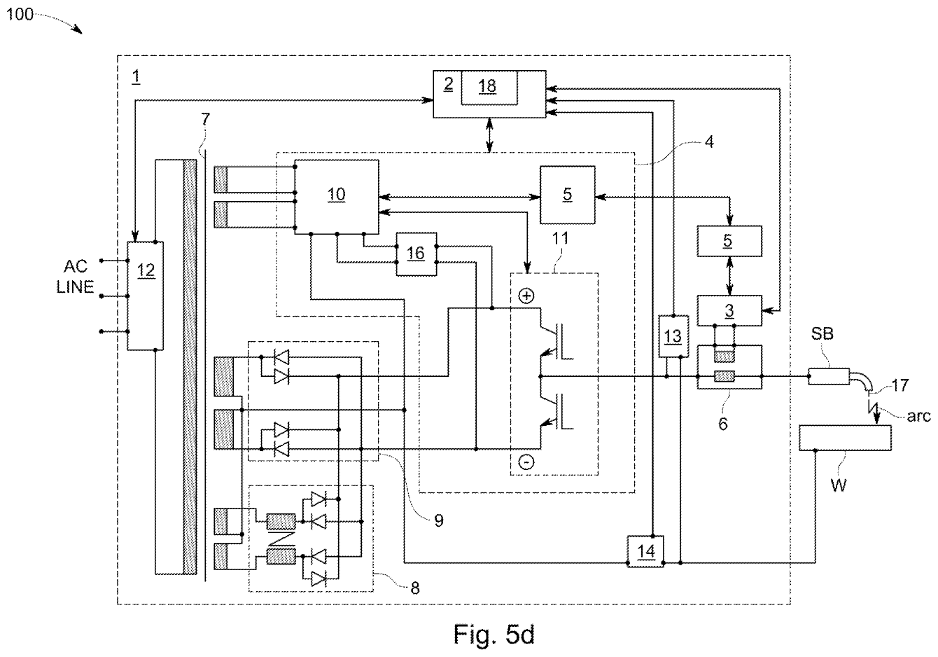

FIG. 5a is a block diagram of a first embodiment of the invention,

FIG. 5b is a block diagram of a second embodiment of the invention,

FIG. 5c is a block diagram of a third embodiment of the invention,

FIG. 5d shows a schematic structure of a welding apparatus.

A welding apparatus 100 shown schematically in FIG. 1a comprises a low-voltage source Q1 which is designed to generate low-voltage pulses P(U1) on a low-voltage side 21. It can also be provided that the low-voltage source Q1 generates a low voltage U1, and a pulse generation unit 23 consequently generates low-voltage pulses P(U1) from the low voltage U1 (not shown in FIG. 1a). The welding apparatus 100 further comprises a transformation unit 20 for converting low-voltage pulses P(U1) towards high-voltage pulses P(U2) applied to a high-voltage side 22 for igniting an arc between an electrode 17 and a workpiece W. In FIG. 1a, an energy limiting unit 5 according to the invention is furthermore provided, which comprises an energy determination unit 51, an energy comparison unit 52 and a blocking unit 53. The energy limiting unit 5 can be connected to the welding apparatus 100 and designed, in an ignition mode of the welding apparatus 100 during a time window T which lasts from a starting time point Ta to an end time point Te, to determine an amount of ignition energy E occurring at an electrode 17 of the welding apparatus. The energy comparison unit 52 is designed to compare the amount of ignition energy E with a predetermined energy limit value G. The blocking unit 53 is designed to trigger an action A when the energy limit value G is exceeded, in order to prevent an occurrence of further ignition energy at the electrode 17 in the time window T. The determination of the amount of ignition energy E and the triggering of the action A are shown only schematically in FIG. 1a on the basis of the dashed arrows. In the following figures, examples of embodiments are described, in which options for the determination of the amount of ignition energy E and the triggering of the action A are described.

FIG. 1b shows, by way of example, a high-frequency (HF) ignition unit 3 of a welding apparatus 100 for generating an arc. A transformation unit 20 is provided in the high-frequency (HF) ignition unit 3, which transformation unit is basically designed to transform a low voltage U1 (e.g. 24 V) on the low-voltage side 21 into a high voltage U2 (e.g. 9.8 kV) on a high-voltage side 22. A low-voltage source Q1 is provided for generating the low voltage U1 on the low-voltage side 21. Furthermore, a pulse generating unit 23 is provided, which generates low voltage pulses P(U1) from the low voltage U1. This can be done, for example, by a switch S which is actuated by the pulse generation unit 23, as indicated in FIG. 1b. Low-voltage pulses P(U1) occurring on the low-voltage side 21 are transformed by means of the transformation unit 20 on the high-voltage side 22, as a result of which high-voltage pulses P(U2) occur on the high-voltage side 22. Using these high-voltage pulses P(U2), an arc is ignited between the electrode 17 and the workpiece W during an ignition process.

Although FIG. 1b shows the transformation unit 20 only as a transformer having a primary winding on the low-voltage side 21 and a secondary winding on the high-voltage side 22, the transformation unit 20 can of course also comprise further elements, in particular further transformers. An input capacitor C1 is provided on the low-voltage side 21, and an output capacitor C2 is provided on the high-voltage side 22.

It should be ensured that the amount of low-voltage energy E1 delivered for generating the arc does not exceed a low-voltage limit value G1 within a time window T. For this purpose, according to the invention an energy limiting unit 5 is provided. The energy limiting unit 5 comprises an energy determination unit 51 which is designed, in an ignition mode or an idle mode, in a time window T which extends from a starting time point Ta to an end time point Te, to determine the amount of low-voltage energy E1 which is guided to the electrode 17. Furthermore, the energy limiting unit 5 comprises an energy comparison unit 52 which is designed to compare the amount of low-voltage energy E1 with a predetermined low-voltage limit value G1. In addition, a blocking unit 53 is provided in the energy limiting unit 5, which blocking unit is designed to trigger an action A when a low-voltage limit value G1 is exceeded, in order to prevent the generation of further low-voltage pulses P(U1), and consequently high-voltage pulses P(U2) transformed therefrom, during the time window T. This prevents the amount of low-voltage energy E1 from increasing further during the time window T, and the low-voltage limit value G1 being exceeded.

In FIG. 1b, the energy determination unit 51 is advantageously designed to determine the amount of low-voltage energy E1 of the low-voltage pulses P(U1) on the low-voltage side 21. Of course, in another embodiment, it is also conceivable that the energy determination unit 51 is designed to determine the amount of high-voltage energy E2 of the high-voltage pulses P(U2) on the high-voltage side 22. Furthermore, in FIG. 1b, the blocking unit 53 is designed, by way of example, to access the pulse generation unit 23 in order to block the generation of further low-voltage pulses P(U1).

A plurality of low-voltage pulses P(U1) can be combined, in each case, on the low-voltage side 21, to form low-voltage pulse packets P1, and can be transformed on the high-voltage side 22, as a result of which high-voltage pulse packets P2 comprising a plurality of high-voltage pulses P(U2) occur on the high-voltage side 22. FIG. 2a shows a (planned) sequence, by way of example, of high-voltage pulse packets P2, each consisting of high-voltage pulses P(U2), and individual high-voltage pulses P(U2) which occur during an ignition process on the high-voltage side 22 after a transformation of corresponding low-voltage pulse packets P1, in each case consisting of low-voltage pulses P(U1), as well as individual low-voltage pulses P(U1). The high-voltage pulse packets P2 occur, for example, at a frequency of 1 kHz up to 100 kHz, the high-voltage pulses P(U2) at a frequency of, for example, 100 kHz up to 10 MHz.

The energy detection unit 51 shown in FIG. 1b can be designed, for example, to count the number of low-voltage pulse packets P1 on the low-voltage side 21 and to multiply these with the energy content of a low-voltage pulse packet P1 (e.g. 1 joule) in order to obtain the summed amount of low-voltage energy E1 and thus the amount of ignition energy E.

In addition, an auxiliary voltage source 10 for generating auxiliary voltage pulses P(U3) which can additionally be applied to the high-voltage side 22 can be provided in the welding apparatus 100. These auxiliary voltage pulses P(U3) can serve to improve an ignition of the arc.

FIG. 1c shows an embodiment of the energy limiting unit 5 in combination with an auxiliary voltage source 10 arranged on a welding transformer 7. The auxiliary voltage source 10 in this case contains two rectifiers R, each having an upstream choke/capacitor combination for current limitation, and a downstream capacitor for smoothing and energy storage. Two auxiliary pulse generation units 15 are provided in this case, which are each designed to actuate one switch S for the generation of an auxiliary voltage pulse P(U3). In the embodiment, two rectifiers R are shown in the auxiliary voltage source 10, in order to be able to emit both negative and positive auxiliary voltage pulses P(U3). An energy determination unit 51 is located in the energy limiting unit 5 and is designed to determine an amount of auxiliary voltage energy E3 of the auxiliary voltage pulses P(U3), in the ignition mode, during the time window T. This is achieved here by summing the auxiliary voltage pulses P(U3). If the amount of ignition energy E is generated only by the auxiliary voltage pulses P(U3), then the amount of ignition energy E corresponds to the amount of auxiliary voltage energy E3. The energy comparison unit 52 is designed to compare the amount of auxiliary voltage energy E3 with a predetermined auxiliary voltage limit value G3. The blocking unit 53 is designed to trigger an action A when the auxiliary voltage limit G3 is exceeded, in order to prevent further auxiliary voltage pulses P(U3) in the time window T, which is achieved here by accessing the auxiliary voltage source 10.

If low-voltage pulses P(U1), and thus high-voltage pulses P(U2) transformed therefrom, and additionally auxiliary voltage pulses P(U3), occur in the time window T, the amount of ignition energy E can be made up of the amount of auxiliary voltage energy E3 and the amount of low-voltage energy E1, or of the amount of auxiliary voltage energy E3 and the amount of high-voltage energy E2. For example, this would correspond to a combination of the embodiments described in FIGS. 1b and 1c.

The energy limiting unit 5 and/or the blocking unit 53 and/or the energy determination unit 51 and/or the energy comparison unit 52 may comprise microprocessor-based hardware, for example a computer or digital signal processor (DSP), in which corresponding software is executed for performing the respective function. The energy limiting unit 5 and/or the blocking unit 53 and/or the energy determination unit 51 and/or the energy comparison unit 52 can also comprise integrated circuits, for example an application-specific integrated circuit (ASIC) or a field programmable gate array (FPGA), or a configurable programmable logic device (CPLD), and/or, in parallel therewith, can be monitored by a microprocessor. The energy limiting unit 5 and/or the blocking unit 53 and/or the energy determination unit 51 and/or the energy comparison unit 52 can also comprise an analog circuit or analog computer. Mixed forms are conceivable as well. It is also possible for different functions to be implemented in the same hardware and/or in different hardware parts. Mixed forms in which individual units are implemented both in hardware and in software are particularly advantageous.

FIGS. 2a to 2c and 4a to 4c each represent a time window T which begins at the time Ta and ends at the time Te. FIG. 3 shows two time windows T1 and T2. For example, one second can be assumed as a value for the duration of a time window T.

In FIG. 2a, merely by way of example, three high-voltage pulse packets P2, which each contain high-voltage pulses P(U2), occur in the time window T. Since the high-voltage pulse packets P2 are transformed from corresponding low-voltage pulse packets P1, the same number of high-voltage pulse packets P2 as low-voltage pulse packets P1, and thus also the same number of high-voltage pulses P(U2) as low-voltage pulses P(L1), are provided in the time window T. Thus, the high-voltage pulses P(U2) in the time window T include an amount of high-voltage energy E2 which corresponds to the amount of low-voltage energy E1 in the same time window T.

The number of low-voltage pulses P(U1) occurring on the low-voltage side 21 in the time window T can, for example, be counted by means of the design of the energy determination unit 51 shown in FIG. 1b and multiplied by the energy content of a low-voltage pulse P(U1) (e.g. 1 joule), in order to obtain the summed amount of low-voltage energy E1, which corresponds to the amount of ignition energy E, if only low-voltage pulses P(U1) and high-voltage pulses P(U2) transformed therefrom, but no auxiliary voltage pulses P(U3), are provided. However, an energy determination unit 51 can also be provided which counts the high-voltage pulses P(U2) occurring in the time window T on the high-voltage side 22, and multiplies these by the energy content of a high-voltage pulse P(U2) (e.g. 1 joule), in order to obtain the summed amount of high-voltage energy E2, which in turn corresponds to the amount of ignition energy E, if only low-voltage pulses P(U1) and high-voltage pulses P(U2) transformed therefrom, but no auxiliary voltage pulses P(U3), are provided.

In FIG. 2b, the time window T comprises a (planned) sequence, by way of example, of auxiliary voltage pulses P(U3). The auxiliary voltage pulses P(U3) are input on the high-voltage side 22 during an ignition process. In the illustration, four auxiliary voltage pulses P(U3), which contain, in total, an amount of auxiliary voltage energy E3, are shown by way of example in the time window T.

The number of auxiliary voltage pulses P(U3) occurring in the time window T can, for example, be counted directly on the auxiliary voltage source by means of the auxiliary voltage energy determination unit 51 shown in FIG. 1c, and multiplied by the energy content of an auxiliary voltage pulse P(U3) (e.g. 1 joule) in order to obtain the summed amount of auxiliary voltage energy E3. The amount of auxiliary voltage energy E3 corresponds to the amount of ignition energy E if only auxiliary voltage pulses P(U3), but no low-voltage pulses P(U1) and high-voltage pulses P(U2) transformed therefrom, are provided.

FIG. 2c represents a combination of high-voltage pulses P(U2) and auxiliary voltage pulses P(U3) occurring on the high-voltage side 22. Furthermore, in FIG. 2c the high-voltage pulses P(U2) are advantageously temporally synchronized, at least in part, with the auxiliary voltage pulses P(U3). Synchronous application of the high-voltage pulses P(U2) and auxiliary voltage pulses P(U3) is referred to as pulse combination K. Furthermore, this illustration shows, in a time window T, four pulse combinations K, i.e., four high-voltage pulses P(U2) with four auxiliary voltage pulses P(U3) synchronized therewith. The pulse combinations K contain an amount of ignition energy E, in the time window T, composed of the amount of high-voltage energy E2 (corresponding to the amount of low-voltage energy E1) and the amount of auxiliary voltage energy E3.

Furthermore, the energy determination unit 51 can also sum the amount of low-voltage energy E1 of the low-voltage pulses P(U1) (or, in an equivalent manner, the amount of high-voltage energy E2 of the high-voltage pulses P(U2)) in the time window T in each case, and separately sum the amount of auxiliary voltage energy E3 of the auxiliary voltage pulses P(U3). This can also take place in separate energy determination units 51. The amount of ignition energy E furthermore corresponds to the sum of the amount of auxiliary voltage energy E3 and the amount of low-voltage energy E1 (or the equivalent amount of high-voltage energy E2).

The summed amount of energy E is forwarded to the energy comparison unit 52. An energy limit value G of for example 4 joules for a 1 second time window T, likewise defined by way of example, was defined beforehand. Furthermore, it is assumed, by way of example, that the pulse combination K corresponds to an amount of energy of 1 joule. The comparison unit 52 determines, for the time window T in FIG. 2c, that the amount of ignition energy E is equal to the energy limit value G (“4 times 1 joule”), as a result of which no action A is triggered. This means that no further high-voltage pulses P(U2), and thus no further low-voltage pulses P(U1) (and possibly no further auxiliary voltage pulses P(U3)), are permitted in the current time window T. Consequently, the comparison unit 52 transmits the task to the blocking unit 53. The blocking unit 53 triggers a corresponding action A. This can take place, for example, in an energy limiting unit 5 according to FIG. 1b or FIG. 1c, by an action performed directly on the pulse generation unit 23 and/or auxiliary coil generation unit 15.

A plurality of time windows T can be provided, wherein the summed amount of low-voltage energy E1 of the included low voltage pulses P(U1) (or the pulse packets P1) are being compared in each case, during the individual time windows T, with a low voltage energy limit value G1. If necessary, the amount of auxiliary voltage energy E3 of the included auxiliary voltage pulses P(U3) can also be summed during each of the individual time windows T, and compared with an auxiliary voltage energy limit value G3.

In the event of the energy limit value G being exceeded within the associated time window T, further high-voltage pulses P(U2) and/or auxiliary voltage pulses P(U3) are prevented in the relevant time window T. The time windows T can overlap (at least in part) and/or follow one another in sequence. Furthermore, different time windows T can be established for different uses, for example in order to document an energy input into a workpiece and, for example, to ensure safety-relevant functions at the same time.

FIG. 3 shows, by way of example, a first time window T1 and a second time window T2 which, merely by way of example, adjoins the first time window T1, as the time window T. In the first time window T1, four auxiliary voltage pulses P(U3) and three high-voltage pulses P(U2) occur. It is possible to conclude from this that three low-voltage pulses P(U1) also occur in the first time window T1. In the second time window T2, which here, merely by way of example, adjoins the first time window T1, four auxiliary voltage pulses P(U3) and three high-voltage pulses P(U2) likewise occur. Assuming that the time windows T1 and T2 each last one second, and a pulse combination K of a high-voltage pulse P(U2) with an auxiliary voltage pulse P(U3) of 1 joule in each case was assumed, both the amount of ignition energy E in the first time window T1 and the amount of ignition energy E in the second time window T2 would be below an energy limit value G of 4 joules. Thus, an action A would not be triggered in either of the two time windows T1 and T2.

However, it is very particularly advantageous if a time window T is provided which always ends at the current time and thus runs along with the current time. This means that the time window T shifts to the right on the time axis t, as a result of which the time window always looks to the past, in real time, to the current time. The current time thus always corresponds to the end time point Te. This can be achieved by recording the time profile of the high-voltage pulses P(U2) and the possibly occurring auxiliary voltage pulses P(U3), at least over a period corresponding to the time window T.

If it is determined, in the process, that the energy limit value G has already been reached in the time window T ending at the current time, the generation of further low-voltage pulses P(U1) (and thus further high-voltage pulses P(U2) and, if auxiliary voltage pulses P(U3) are provided, the generation of further auxiliary voltage pulses P(U3) is prevented, until, due to the shifting of the time window T, low-voltage pulses P(U1) (and thus high-voltage pulses P(U2)) and optionally auxiliary voltage pulses P(U3) correspondingly slip out of the time window T, as a result of which the amount of ignition energy E in the time window T no longer reaches the energy limit value G.

In FIG. 4a to 4c, a time window T is shifted to the right in each case. The current time corresponds to the end time point Te, and the time window T is viewed backwards in time to the starting time point Ta. It is again assumed that a pulse combination K, which consists of a high-voltage pulse P(U2) having a synchronized auxiliary voltage pulse P(U3), contains an amount of energy of one joule, and the energy limit value G corresponds to four joules.

In FIG. 4a, four pulse combinations K occur in the time window T, as a result of which the energy limit value G is not exceeded but has been reached. Since the energy limit value G has been reached, the request for a new pulse combination K, at the time Te, was blocked by the action A, and therefore no further pulse combination K was generated as long as these four pulse combinations K are contained in the time window T. In this case, the time window T is shifted continuously to the right.

FIG. 4b shows a later point in time with respect to FIG. 4a, at which the first pulse combination K has already slid out of the time window T, and thus a further pulse combination K has been generated in the time window T. Furthermore, the non-generated pulse combination K is also shown in dashed lines in FIG. 4b, a cross again illustrating that this pulse combination K does not enter into the calculation of the amount of ignition energy E, since this further pulse combination K was not generated as described in FIG. 4a. Thus, in FIG. 4b, the amount of ignition energy E corresponds again to the energy limit value G. This means that no further pulse combination K is permitted in the time window T until at least one further pulse combination K has slid out of the time window T. Thus, an action A prevents a further pulse combination K from occurring in the shiftable time window T. It should be noted that the previously blocked pulse combination K is also not counted subsequently, when determining the amount of ignition energy E, since this pulse combination K was only planned, but was actively prevented by an action A, and thus the energy was not delivered to the electrode 17.

In FIG. 4c, the time window T is slid further to the right, and another further pulse combination K would have been provided at the current end time point Te. The pulse combination K shown by dashed lines is once again blocked by triggering the action A (which is again represented by a cross), in order to ensure that the amount of ignition energy E does not exceed the energy limit value G.

FIG. 5a shows a first schematic embodiment of the invention. A power source 1 contains, inter alia, a process controller 2, an internal high-frequency (HF) ignition unit 3, an internal inverter 4 having an auxiliary voltage source 10, and an energy limiting unit 5. The process controller 2 is connected to the energy limiting unit 5, the high-frequency (HF) ignition unit 3 and the inverter 4, and consequently the auxiliary voltage source 10. The energy limiting unit 5 is additionally connected to the high-frequency (HF) ignition unit 3 and the inverter 4, and consequently to the auxiliary voltage source 10. The internal high-frequency HF ignition unit 3 generates low-voltage pulses P(U1) which are transformed into high-voltage pulses P(U2). For this purpose, the high-frequency HF ignition unit 3 can include, inter alia, a low-voltage source Q1, a pulse generation unit 23 and a transformation unit 20, as described above. The inverter 4, having an integrated auxiliary voltage source 10, supplies auxiliary voltage pulses P(U3). In order to ignite an arc, the process controller 2 requests low-voltage pulses P(U1) at the high-frequency (HF) ignition unit 3, and auxiliary voltage pulses P(U3) at the internal inverter 4 having an auxiliary voltage source 10. The high-voltage pulses P(U2) and the auxiliary voltage pulses P(U3) are combined and guided via a welding cable and via the welding torch SB to the electrode 17. An arc is ignited between the tip of the electrode 17 and the workpiece W. In this embodiment, a single energy limiting unit 5, comprising an energy determination unit 51, an energy comparison unit 52 and a blocking unit 53, is provided, the energy determination unit 51 summing, in the time window T, the amount of ignition energy E, consisting of the amount of low-voltage energy E1 of the low voltage pulses P(U1) and the amount of auxiliary voltage energy E3 of the auxiliary voltage pulses P(U3). In the case of a desired energy limitation (i.e., prevention of further ignition energy E in the time window T), which is to take place by the amount of ignition energy E exceeding the energy limit value G, triggering of an action A blocks low-voltage pulses P(U1) and consequently high-voltage pulses P(U2) and/or auxiliary voltage pulses P(U3). Furthermore, it is also possible for the high-frequency (HF) ignition unit 3 and the inverter 4 to be located outside the power source 1.

FIG. 5b shows a second schematic embodiment of the invention. A power source 1 contains, inter alia, a process controller 2, an internal high-frequency (HF) ignition unit 3, an internal inverter 4 having an auxiliary voltage source 10, and two separate energy limiting units 5 communicating with one another. The process controller 2 is connected to both energy limiting units 5, the high-frequency (HF) ignition unit 3 and the inverter 4, and consequently the auxiliary voltage source 10. The two energy limiting units 5 are coupled and are additionally connected to the high-frequency (HF) ignition unit 3 and the inverter 4, and consequently to the auxiliary voltage source 10. The internal high-frequency (HF) ignition unit 3 generates low-voltage pulses P(U1) which are transformed into high-voltage pulses P(U2) and can, for this purpose, comprise inter alia a low-voltage source Q1, a pulse generation unit 23, and a transformation unit 20, as described above. The inverter 4, having an integrated auxiliary voltage source 10, supplies auxiliary voltage pulses P(U3). The process controller 2 requests the low-voltage pulses P(U1) and/or the auxiliary voltage pulses P(U3) for an ignition of an arc, directly at the high-frequency (HF) ignition unit 3 and the internal inverter 4 comprising an auxiliary voltage source 10. The high-voltage pulses P(U2) and the auxiliary voltage pulses P(U3) are combined and guided via a welding cable and via the welding torch SB to the electrode 17. An arc is ignited between the tip of the electrode 17 and the workpiece W. In this embodiment, two energy limiting units 5 communicating with one another are provided, which sum the amount of ignition energy E. The first energy limiting unit 5 sums the amount of low-voltage energy E1 of the low-voltage pulses P(U1), and the second energy limiting unit 5 sums the amount of auxiliary voltage energy E3 of the auxiliary voltage pulses P(U3). In addition, each or at least one of the two energy limiting units 5 knows the entire amount of ignition energy E, which represents the sum of the amount of low-voltage energy E1 and the amount of auxiliary voltage energy E3. In the case where the energy is limited by exceeding the energy limit value G in the time window T, low-voltage pulses P(U1), and consequently high-voltage pulses P(U2) and/or auxiliary voltage pulses P(U3), are blocked by at least one energy limiting unit 5. Thus, in this embodiment, two energy limiting units 5 communicating with one another are shown, which together ensure that the energy limit value G is not exceeded. In another embodiment, two separate energy determination units 51 can also be provided, which jointly determine the amount of ignition energy E and communicate with one another, in this further embodiment the amount of ignition energy E being compared with an energy limit value G in a central energy limiting unit 5. Furthermore, it is also possible for the high-frequency (HF) ignition unit 3 and/or the inverter 4 to be located, together with the auxiliary voltage source 10 with the respective energy-limiting units 5 or with the energy determination units 51, outside the power source 1.

In addition, it is also possible in FIG. 5b for the first energy limiting unit for example to limit the amount of low-voltage energy E1 to a first defined threshold value, and for the second energy limiting unit 5 for example to limit the amount of auxiliary voltage energy E3 to a second defined limit value. Both limit values can also be different in this case. The two internal energy limiting units 5 jointly limit the amount of ignition energy E to a third defined limit value. In this case, the sum of both limit values always remains below the previously defined energy limit value G.

FIG. 5c shows a third schematic embodiment of the invention. A power source 1 contains, inter alia, a process controller 2 and an energy comparison unit 52 and an internal inverter 4 having an auxiliary voltage source 10 and an energy determination unit 51 and a blocking unit 53. An external high-frequency (HF) ignition unit 3 is arranged outside the current source 1, and has its own energy detection unit 51 and its own blocking unit 53. The energy limiting unit 5 is realized in a distributed manner in this case, and thus comprises an energy comparison unit 52, two energy determination units 51 and two blocking units 53, which is indicated in FIG. 5c by the arrows. The energy limiting unit 5 is realized by a connection of the two energy determination units 51 to the energy comparison unit 52. The process controller 2 is connected to the energy comparison unit 52 and thus to the energy limiting unit 5 constructed from internal and external components, the external high-frequency (HF) ignition unit 3 and the inverter 4, and consequently the auxiliary voltage source 10. The external high-frequency (HF) ignition unit 3 generates low-voltage pulses P(U1) which are transformed into high-voltage pulses P(U2) and can, for this purpose, include inter alia a low-voltage source Q1, a pulse generation unit 23 and a transformation unit 20, as described above. The internal inverter 4 having an integrated auxiliary voltage source 10 supplies auxiliary voltage pulses P(U3). The process controller 2 requests the low-voltage pulses P(U1) and/or the auxiliary voltage pulses P(U3) for an ignition of an arc, directly at the external high-frequency (HF) ignition unit 3 and the internal inverter 4 having the auxiliary voltage source 10. The high-voltage pulses P(U2) and the auxiliary voltage pulses P(U3) are combined and guided via a welding cable and via the welding torch SB to the electrode 17. An arc is ignited between the tip of the electrode 17 and the workpiece W. In this embodiment, two separate energy determination units 51 are provided, which communicate in an energy limiting unit 5 and which sum the amount of ignition energy E. The first energy determination unit 51 sums the amount of low-voltage energy of the low-voltage pulses P(U1), and the second energy determination unit 51 sums the amount of auxiliary voltage energy E3 of the auxiliary voltage pulses P(U3). The energy limiting unit 5 knows the entire ignition energy E, which represents the sum of amount of low-voltage energy E1 and amount of auxiliary voltage energy E3. In the case of energy limitation by exceeding the energy limit value G in the time window T, further low-voltage pulses P(U1), and consequently high-voltage pulses P(U2) and/or auxiliary voltage pulses P(U3), are blocked, by an action A, by the blocking units 53, in the time window T.

The embodiments shown here represent merely examples. In addition to the examples shown here, all combinations of inverters 4, auxiliary voltage sources 10, internal or external arrangements, number of energy limiting units 5, and the communication of the energy limiting units 5 with one another are possible, with a very wide variety of different combinations of limit values.

FIG. 5d shows an embodiment of a welding apparatus 100 in terms of circuitry, comprising two communicating energy limiting units 5 according to the invention. The welding apparatus 100 comprises a power source 1, a welding torch SB and an electrode 17. The electrode 17 is located at one end of the welding torch SB, the second end of the welding torch SB is connected to the power source 1, and an arc is ignited between the electrode 17 and the workpiece W, the workpiece W likewise being connected to the power source 1 by a ground wire. The power source 1 is connected on the input side to an electrical supply network AC LINE. The power source 1 comprises a process control unit or a process controller 2 having, for example, an integrated user interface 18, a high-frequency (HF) ignition unit 3, an inverter 4, two energy limiting units 5, a high-voltage transformer unit 6, a welding transformer 7, an open circuit voltage increase 8, a secondary rectifier 9, an auxiliary voltage source 10, a polarity reversal unit 11, a primary power unit 12, a process voltage measurement 13, a process current measurement 14, and a detection unit 16. A high-frequency (HF) ignition unit 3 by way of example, having an associated energy limiting unit 5, is shown in detail in FIG. 1b, and an auxiliary voltage source 10, by way of example, having an associated energy limiting unit 5, is shown in detail in FIG. 1c. Starting from a low-frequency 50/60 Hz AC mains voltage of the electrical supply network AC LINE (single phase or multi-phase; 100 V to 600 V), this voltage is converted with the aid of the primary power unit 12 into a high-frequency AC voltage (for example 1 kHz to several 100 kHz). The primary power unit 12 is connected to the process controller 2, and said controller controls the energy flow. The converted high-frequency AC voltage is fed to the welding transformer 7 on the primary winding side, which transformer transforms said voltage, on the secondary winding side, with the low voltages and high current intensities typical for the welding process. The secondary rectifier 9, which is designed, for example, as a full-wave rectifier having a center tap, and can thus provide positive and negative output voltages, is located on the secondary winding side of the welding transformer 7. The secondary rectifier 9 is connected to the polarity reversal unit 11 of the inverter 4 and supplies the predominant current component in a welding process. The open circuit voltage step-up 8 is located on the secondary winding side of the welding transformer 7. The open circuit voltage step-up 8 is connected in parallel with the secondary rectifier 9 and provides for an increase in voltage of the open circuit voltage of, for example, 60 V to up to 113 V. The open circuit voltage step-up 8 can also provide both positive and negative voltages. The open circuit voltage step-up 8 can provide assistance during the ignition of the arc, but only delivers a limited current through the coupled choke. Furthermore, erratic arcs can be prevented to a certain extent by the open circuit voltage step-up 8. If the open circuit voltage step-up 8 is not sufficient, the auxiliary voltage source 10 is switched on in order to prevent an erratic arc. The auxiliary voltage source 10, which is in turn located in the inverter 4, is additionally located on the secondary winding side of the welding transformer 7. Furthermore, the auxiliary voltage source 10, and thus also the energy limiting unit 5, is connected to the polarity reversal unit 11 via the detection unit 16. The polarity reversal unit can comprise, for example, semiconductor transistors such as IGBTs, MOSFETs, bipolar transistors, etc. The polarity reversal unit 11 switches the voltage coming from the open circuit voltage step-up 8 and/or the voltage coming from the secondary rectifier 9 and/or the voltage coming from the auxiliary voltage source 10 to the polarity predetermined by the process controller 2, at the electrode 17. The detection unit 16 measures and identifies a current flow, and thus detects a welding mode/idle mode/ignition mode. An energy limiting unit 5, which is in turn connected to the auxiliary voltage source 10, is located in the inverter 4. Said energy limiting unit 5 substantially resembles the embodiment shown in FIG. 1c. In order to regulate the welding process, a process voltage measurement 13 and a process current measurement 14 are used by the process controller 2. The process controller 2 requests the high-voltage pulses P(U2) at the high-frequency (HF) ignition unit 3, and the auxiliary voltage pulses P(U3) at the inverter 4, for arc ignition or arc stabilization. In this embodiment, the high-voltage pulses P(U2) of the high-voltage (HF) ignition unit 3 are coupled into the welding circuit by means of a high-voltage transformer unit 6. The energy limiting unit 5 for the high-voltage (HF) ignition unit 3 communicates with the energy limiting unit 5 for the inverter 4 and ensures an ignition mode that is not safety-critical. The user interface 18 serves as an interface between the operator and the process controller 2.

1. A method for safe operation of a welding apparatus, low-voltage pulses occurring on a low-voltage side of the welding apparatus being transformed into high-voltage pulses occurring on a high-voltage side of the welding apparatus, an arc being ignited between an electrode and a workpiece during an ignition mode and/or idling mode using the high-voltage pulses, wherein, in the ignition mode and/or in the idling mode and/or in a welding mode, a time window that extends from a starting time point to an end time point is provided, an amount of ignition energy occurring at the electrode being determined during the time window and compared with an energy limit value, and in that an action is triggered in the event of the energy limit value being exceeded, in order to prevent further high-voltage pulses in the time window.

2. The method according to claim 1, wherein an amount of high-voltage energy of the high-voltage pulses is summed during the time window, and in that the amount of high-voltage energy is used to determine the amount of ignition energy occurring at the electrode.

3. The method according to claim 2, wherein the amount of energy of one high-voltage pulse is predefined, and in that the high-voltage pulses occurring during the time window are counted and multiplied by the amount of energy of one high-voltage pulse in order to determine the amount of high-voltage energy summed during the time window.

4. The method according to claim 1, wherein, during the time window, an amount of low-voltage energy of the low-voltage pulses is summed, and in that the amount of low-voltage energy is used to determine the amount of ignition energy occurring at the electrode.

5. The method according to claim 4, wherein the amount of energy of one low-voltage pulse is predefined, and in that the low-voltage pulses occurring during the time window are counted and multiplied by the amount of energy of one low-voltage pulse in order to determine the amount of low-voltage energy summed during the time window.

6. The method according to claim 4, wherein the amount of energy of one low-voltage pulse per time unit is predefined, and in that the sum of the pulse durations of the low-voltage pulses occurring during the time window is determined and multiplied by the amount of energy of one low-voltage pulse per time unit, in order to determine the amount of low-voltage energy summed during the time window.

7. The method according to claim 1, wherein auxiliary voltage pulses are applied on the high-voltage side in order to support the ignition of an arc, and in that, during the time window, an amount of auxiliary voltage energy of the auxiliary voltage pulses is summed, in order to determine an amount of auxiliary voltage energy, in that the amount of auxiliary voltage energy is used to determine the amount of ignition energy occurring at the electrode, and in that further auxiliary voltage pulses are prevented by triggering the action in the time window.

8. The method according to claim 7, wherein the auxiliary voltage pulses are temporally synchronized, preferably superimposed, with the high-voltage pulses, or the high-voltage pulses are temporally synchronized, preferably superimposed, with the auxiliary voltage pulses.

9. The method according to claim 7, wherein the amount of energy of an auxiliary voltage pulse is predefined, in that the auxiliary voltage pulses occurring during the time window are counted and multiplied by the amount of energy of an auxiliary voltage pulse, in order to determine the amount of auxiliary voltage energy summed during the time window.

10. The method according to claim 7, wherein the amount of energy of an auxiliary voltage pulse per time unit is predefined, in that the sum of the pulse durations of the auxiliary voltage pulses occurring during the time window is determined and multiplied by the amount of energy of an auxiliary voltage pulse per time unit, in order to determine the amount of auxiliary voltage energy summed during the time window.

11. The method according to claim 7, wherein, in the time window, a residual amount of energy is determined from a difference between the energy limit value and the amount of ignition energy, and a determination is made, on the basis of the residual amount of energy, as to whether further auxiliary voltage pulses and/or high-voltage pulses will be prevented by a triggered action in the time window.

12. The method according to claim 1, wherein the time window is continuously shifted in real time, such that the end time point corresponds to the current time.

13. The method according to claim 1, wherein, as an action, the generation of further low-voltage pulses and consequently high-voltage pulses and/or auxiliary voltage pulses is blocked.

14. The method according to claim 1, wherein the triggering of the action is deactivated when the welding apparatus is in a welding mode.

15. An energy limiting unit for a welding apparatus having a low-voltage side and a high-voltage side, wherein the energy-limiting unit comprises at least one energy determination unit which is designed to determine an amount of ignition energy occurring at an electrode in an ignition mode and/or an idle mode and/or a welding mode of the welding apparatus during a time window which extends from a starting time point to an end time point, in that the energy limiting unit comprises at least one energy comparison unit which is designed to compare the amount of ignition energy to a predetermined energy limit value, and in that the energy limiting unit comprises at least one blocking unit which is designed to trigger an action when the energy limit value is exceeded, in order to prevent an occurrence of further ignition energy at the electrode in the time window.

16. An energy limiting unit according to claim 15, wherein a detection unit is provided, which is designed to distinguish the welding mode of the welding apparatus from the ignition mode and/or idle mode of the welding apparatus, and to deactivate at least one energy determination unit and/or at least one energy comparison unit and/or at least one blocking unit in the welding mode, and to activate it in the ignition mode and/or idle mode.

17. An welding apparatus comprising a low-voltage source which is designed to generate low-voltage pulses on the low-voltage side, and comprising a transformation unit for converting low-voltage pulses to high-voltage pulses applied to a high-voltage side for igniting an arc between an electrode and a workpiece, and comprising at least one energy limiting unit according to claim 15, wherein the blocking unit is designed to prevent an occurrence of further ignition energy at the electrode, by the action in the time window, in that further low-voltage pulses on the low-voltage side and/or high-voltage pulses on the high-voltage side and/or auxiliary voltage pulses on the high-voltage side are prevented.
